(19) United States
(12) Patent Application Publication
(10) Pub. No.: US 2013/0265645 A1
(43) Pub. Date: Oct. 10, 2013

(54) MOUNTING STRUCTURE FOR OPTICAL COMPONENT, WAVELENGTH-SELECTIVE DEVICE, AND METHOD FOR MANUFACTURING MOUNTING STRUCTURE FOR OPTICAL COMPONENT

(71) Applicant: SUMITOMO ELECTRIC INDUSTRIES, LTD., Osaka-shi (JP)

(72) Inventors: Manabu Izaki, Yokohama-shi (JP); Satoshi Yoshikawa, Yokohama-shi (JP)

(73) Assignee: Sumitomo Electric Industries, Ltd., Osaka-shi (JP)

(21) Appl. No.: 13/857,697

(22) Filed: Apr. 5, 2013

(30) Foreign Application Priority Data
Apr. 9, 2012 (JP) 2012-088567

(51) Int. Cl. G02B 7/18; G02B 27/10; G02B 5/08

(52) U.S. Cl. CPC G02B 7/1805; G02B 5/08; G02B 27/1006
USPC 359/615; 359/883; 156/60

(57) ABSTRACT

Provided is a mounting structure for an optical component, including: an optical component having at least one of a reflective surface which reflects light, and a transmissive surface which transmits light; a base member having a placement surface configured to place the optical component thereon; and an adhesive layer interposed between the optical component and the placement surface of the base member to fixedly bond the optical component and the placement surface together. The adhesive layer includes a filler, and the filler is present substantially as a monolayer between the optical component and the placement surface.

### TECHNICAL FIELD

The present invention relates to a mounting structure for an optical component, a wavelength-selective device, and a method for manufacturing a mounting structure for an optical component.

### BACKGROUND

Japanese Patent Application Publication No. 2004-010758 describes a bonded structure for mounting an optical element on a frame. In this bonded structure, when the optical element is adhesively fixed to the frame, a highly thixotropic filler-rich adhesive is used to perform bonding with a high positional accuracy, while providing a gap between the optical element and the frame. The drawbacks of the filler-rich adhesive having a low adhesive force and readily causing floating are compensated by a filler-poor adhesive having a low viscosity.

Japanese Translation of PCT Application No. 2009-508159 describes an optical fiber wavelength-selective switch for channel routing. In such a wavelength-selective switch, a beam is laterally expanded and then each wavelength component is oriented by a polarization rotation device. The oriented beam is directed toward an output port corresponding to each wavelength component. The orientation is assigned by a MEMS or a LCOS array. This document indicates that a member (prism or the like) constituted by quartz with an adjusted refractive index is used as an optical component for laterally expanding the beam or an optical component that orients the beam.

### SUMMARY

When an optical component such as a prism or a mirror is fixed to a base member in an optical device, for example, a wavelength-selective switch, the inclination of the optical component should be controlled with a high accuracy. In particular, in a wavelength-selective switch, the inclination of the optical component shifts the selected wavelength, and therefore a very high accuracy is required for the inclination of the optical component. Accordingly, when such an optical device is manufactured, a certain gap is left between the optical component and the base member, an adhesive is introduced into the gap in a state with the floating optical component, the inclination of the optical component is adjusted, and the adhesive is thereafter cured, for example, as described in Japanese Patent Application Publication No. 2004-010758.

However, where the adhesive is thus cured in a state in which the optical component floats above the base member, there is a spread in the degree of deformation of the adhesive among the optical devices. When filler is contained in the adhesive, this phenomenon becomes particularly remarkable due to deviation of the distribution of the filler. Further, the spread in the degree of deformation causes a spread in the inclination of optical components after the adhesive is cured. Therefore, the inclination of the optical component is difficult to control with a high accuracy.

A mounting structure for an optical component according to one aspect of the present invention includes: an optical component having at least one of a reflective surface which reflects light, and a transmissive surface which transmits light; a base member having a placement surface configured to place the optical component thereon; and an adhesive layer interposed between the optical component and the placement surface of the base member to fixedly bond the optical component and the placement surface together, wherein the adhesive layer includes a filler; and the filler is present substantially as a monolayer between the optical component and the placement surface.

In such a mounting structure for an optical component, the filler contained in the adhesive layer is present substantially as a monolayer between the optical component and the placement surface. Such a monolayer filler maintains a constant spacing between the optical component and the placement surface of the base member. Therefore, with such a mounting structure for an optical component, the inclination of the optical component can be controlled with a high accuracy. The substantial monolayer as referred to herein means that very small particles generated due to cracking or chipping of the filler are not included in the number of layers of the filler. The adhesive layer including such a substantially monolayer filler can be realized, for example, by interposing an adhesive between the optical component and the placement surface of the base member and then pressing (pushing) the optical component against the base member.

For example, a material with a small thermal expansion coefficient, such as Super-Invar, may be used as the constituent material of the base member in order to inhibit changes in the distance between the optical components caused by temperature variations. Meanwhile, for example, quartz with an adjusted refractive index is selected as the constituent material of the optical component with consideration for light transmission or reflection characteristics. Therefore, the linear expansion coefficient of the optical component can be significantly different from that of the base member. Even in such a case, with the above-described mounting structure for an optical component, stresses generated between the optical component and the base member due to temperature variations can be absorbed by the resin component of the adhesive layer, and the optical component can be effectively prevented from cracking or the like.

Further, a mounting structure for an optical component according to another aspect of the present invention includes: an optical component having at least one of a reflective surface which reflects light, and a transmissive surface which transmits light; a base member having a placement surface configured to place the optical component thereon; and an adhesive layer interposed between the optical component and the placement surface of the base member to fixedly bond the optical component and the placement surface together, wherein the adhesive layer includes a filler; and a thickness of the adhesive layer between the optical component and the placement surface is less than twice an average particle size of the filler.

When the thickness of the adhesive layer between the optical component and the placement surface is thus less than twice an average particle size of the filler, it can be said that the filler in the adhesive layer is present substantially as a monolayer. Therefore, according to this mounting structure for an optical component, a constant spacing can be maintained between the optical component and the placement surface of the base member with monolayer filler, and the inclination of the optical component can be controlled with a high accuracy.

In the above-described mounting structure for an optical component, the range of a particle size distribution of the filler may be within 20 μm. Where the spread in the particle size of the filler is thus small, the inclination of the optical component can be controlled with an even higher accuracy.

In the above-described mounting structure for an optical component, the linear expansion coefficient of the optical component may be ten or more times a linear expansion coefficient of the base member. Even in such a case in which the linear expansion coefficient of the optical component is significantly different from that of the base member, with the above-described mounting structure for an optical component, stresses generated between the optical component and the base member due to temperature variations can be absorbed by the resin component of the adhesive layer, and the optical component can be effectively prevented from cracking or the like. The optical component and base member have such a significant difference in linear expansion coefficient, for example, when the optical component is made of glass and the base member is made of Invar or Super-Invar.

In the above-described mounting structure for an optical component, the base member may further include a groove formed to surround the placement surface. Where the base member has such a groove, for example, the following two configurations of the adhesive layer can be considered. In the first configuration, the outer edge of the adhesive layer is confined within a region surrounded by the groove. In the second configuration, the outer edge of the adhesive layer reaches an interior of the groove.

Where the outer edge of the adhesive layer is confined within a region surrounded by the groove, the presence range of the adhesive layer is limited to the interior of the region surrounded by the groove. Therefore, even when the linear expansion coefficient of the optical component is significantly different from that of the base member, the stretching degree of the adhesive layer in the in-plane direction along the placement surface can be limited to a certain value. Where the outer edge of the adhesive layer reaches an interior of the groove, the contact surface area of the base member and adhesive layer is enlarged by comparison with that in the case where the groove is not present. Therefore, the fixing strength of the optical component to the base member can be increased.

The above-described mounting structure for an optical component may include a plurality of the optical components; the base member having a plurality of the placement surfaces; and a plurality of the adhesive layers interposed between the plurality of optical components and the plurality of placement surfaces, wherein each of the plurality of optical components may be optically coupled to another optical component included in the plurality of optical components. With such a mounting structure for an optical component, the monolayer filler can maintain a constant spacing between the optical component and the placement surface of the base member, and therefore the inclination of the optical component can be controlled with a high accuracy and the optical components can be optically coupled with a high accuracy.

A wavelength-selective device according to one aspect of the present invention includes: a beam port that inputs a beam; a beam expansion unit that expands the beam inputted from the beam port; a spectral element that divides the beam expanded by the beam expansion unit into different optical paths for each wavelength component of the beam; and a converging lens that converges the beam at different positions for each wavelength component divided by the spectral element, wherein at least one optical component from among the beam expansion unit, the spectral element, and the converging lens is mounted on the base member by any of the above-described mounting structures for an optical component. With such a wavelength-selective device, the monolayer filler included in the adhesive layer can maintain a constant spacing between the base member and the optical component such as the beam expansion unit, spectral element or converging lens. Therefore, the inclination of the optical component such as the beam expansion unit, spectral element or converging lens can be controlled with a high accuracy and those optical components can be optically coupled with a high accuracy. As a result, the shift of the selected wavelengths can be effectively inhibited.

In the wavelength-selective device, the beam expansion unit may be constituted by a plurality of prisms that are optically coupled to each other. With such a wavelength-selective device, the plurality of prisms of the beam expansion unit can be optically coupled to each other with a high accuracy.

A method for manufacturing a mounting structure for an optical component according to another aspect of the present invention includes the steps of: coating an adhesive including a filler on a placement surface of a base member, the placement surface being a surface configured to place an optical component having at least one of a reflective surface which reflects light, and a transmissive surface which transmits light; placing the optical component on the placement surface; causing the filler to be present substantially as a monolayer between the optical component and the placement surface by pushing the optical component toward the placement surface; and curing the adhesive to form an adhesive layer.

In the above-described manufacturing method, the base member is further provided with a groove formed such as to surround the placement surface, and an extra amount of the adhesive may be allowed to escape to the groove in the causing.

The present invention will be more fully understood from the detailed description given herein below and the accompanying drawings, which are given by way of illustration only and are not to be considered as limiting the present invention.

Further, scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIG. 1 is a side sectional view illustrating the mounting structure for an optical component of the first embodiment;

FIG. 2 is an assembled view of the mounting structure for an optical component;

FIG. 3 is a graph illustrating an example of particle size distribution of the filler;

FIG. 4 is a flowchart illustrating an example of the method for manufacturing the mounting structure for an optical component;

FIG. 5 is a graph illustrating an example of the relationship between a pushing force used when bonding the optical component to the base member and the thickness of the adhesive layer;

FIG. 6 is a side sectional view illustrating the configuration of the mounting structure for an optical component as a variation example of the first embodiment;

FIG. 7 is a side sectional view illustrating the configuration of the mounting structure for an optical component as another variation example of the first embodiment; and

FIG. 8 is a perspective view illustrating the configuration of a wavelength-selective device as the second embodiment of the mounting structure for an optical component.

### DETAILED DESCRIPTION

Embodiments of the mounting structure for an optical component, the wavelength-selective device, and the method for manufacturing the mounting structure for an optical component in accordance with the present invention are explained in detail below with reference to the appended drawings. The same reference numerals are assigned to the same elements, and a repeated description thereof is omitted.

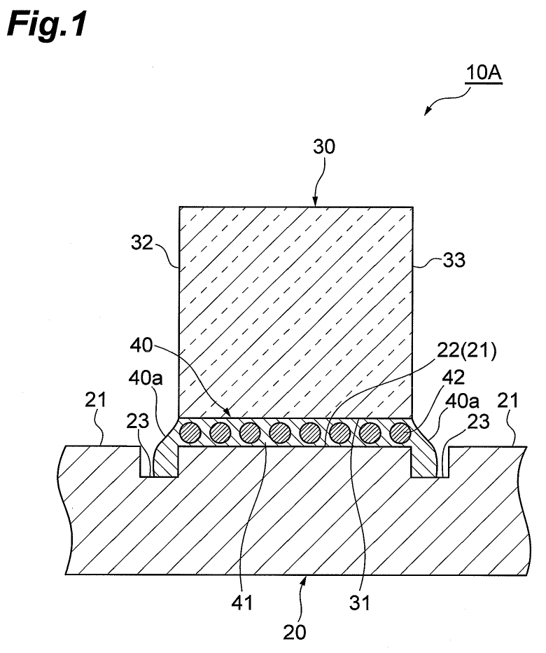

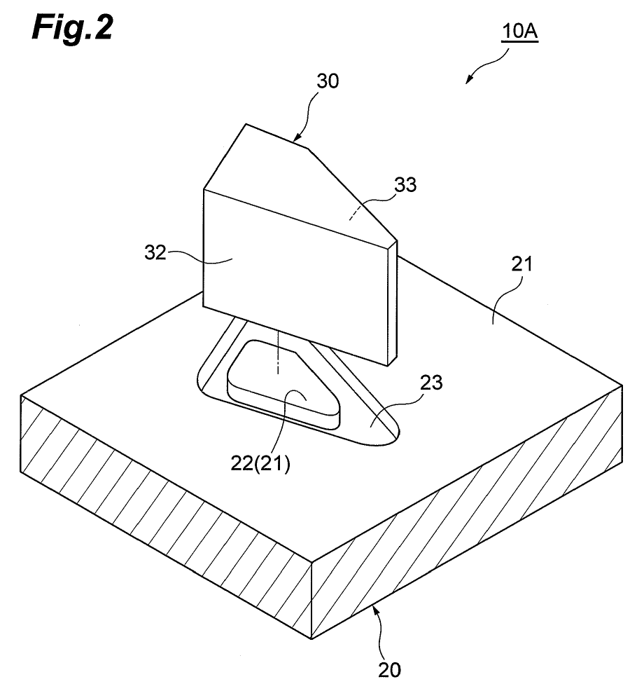

(First Embodiment) FIG. 1 is a side sectional view illustrating a mounting structure 10A for an optical component according to the first embodiment. FIG. 2 is an assembled view of the mounting structure 10A for the optical component. The mounting structure 10A for an optical component shown in FIGS. 1 and 2 is provided with a base member (base) 20, an optical component 30, and an adhesive layer 40 (omitted in FIG. 2). The base member 20 mechanically supports the optical component 30 and is constituted, for example, by a metal plate-shape member. The base member 20 is preferably composed of a material (for example, Invar or Super-Invar) having a small linear expansion coefficient, such that the distance between the optical component 30 and other optical components placed on the base member 20 does not change due to variations in the ambient temperature. The linear expansion coefficient of the base member 20 is, for example, 1×10⁻⁶ (/deg ° C.).

The base member 20 has a main surface 21, and the main surface 21 includes a placement surface 22 onto which the optical component 30 is placed. The placement surface 22 is a substantially flat surface oriented along a predetermined plane and has a flat shape substantially identical to that of the adhesive surface 31 of the optical component 30 facing the placement surface 22. The surface area of the placement surface 22 is, for example, 20 mm² or less. A groove 23 is formed in the main surface 21 of the base member 20. The groove 23 is formed along the outer periphery of the placement surface 22 so as to surround the placement surface 22. As shown in FIG. 1, the groove is formed in order to accommodate the excess amount of the adhesive when the adhesive layer 40 is formed.

The optical component 30 has at least one of a light reflective surface which reflects light, and a light transmissive surface which transmits light. Examples of the optical component 30 include light-transmissive optical components such as prisms, lenses, and polarization-separating optical elements, and light-reflective optical components such as mirrors and diffraction gratings. For example, in FIG. 2, a prism having light transmissive surfaces 32, 33 is shown as the optical component 30. Were the optical component 30 is light transmissive, glass (quartz or the like) with a composition adjusted so as to have the preferred refractive index with respect to the wavelength of the light to be transmitted is preferred as the constituent material of the optical component 30. In this case, the linear expansion coefficient of the optical component 30 can be, for example, equal to higher than 1×10⁻⁵ (/deg ° C.) and ten or more times the linear expansion coefficient of the base member 20. The mass of the optical component 30 is, for example, equal to or less than 10 g.

In an example, the light transmissive surface (for example, the light transmissive surfaces 32, 33 shown in FIG. 2) or light reflective surface of the optical component 30 extends in the direction (typically, the direction perpendicular to the main surface 21) crossing the main surface 21 of the base member 20 including the placement surface 22, and the optical axis of the light incident on the light transmissive surface or light reflective surface extends along the main surface 21.

Further, the optical component 30 has a bonding surface 31 facing the placement surface 22 of the base member 20. The bonding surface 31 extends in the direction crossing the light transmissive surface or light reflective surface of the optical component 30 and extends along the placement surface 22 of the base member 20.

The adhesive layer 40 is interposed between the placement surface 22 of the base member 20 and the bonding surface 31 of the optical component 30 and serves to bond fixedly the base member 20 and the optical component 30 together. The adhesive layer 40 includes a resin 41 curable by heat or ultraviolet radiation and a large number of particles of a filler 42 admixed to the resin 41. The resin 41 mainly includes an organic material, for example, such as an epoxy resin, an acrylic resin, or a silicone resin. As mentioned hereinabove, the linear expansion coefficient of the optical component 30 is sometimes substantially higher than the linear expansion coefficient of the base member 20. In such a case, it is preferred that the resin 41 be constituted of a material with comparatively high stretching ability after curing in order to relax the stresses (internal stresses, or external stresses such as vibrations and shocks; generated in the direction along the placement surface 22) generated between the base member 20 and the optical component 30 due to variations in the ambient temperature. The filler 42 is in the form of fine solid particles constituted by a material different from that of the resin 41. For example, the filler is constituted by an inorganic material such as silicon dioxide, metals, or Al₂O₃.

As shown in FIG. 1, the filler 42 is present substantially as a monolayer between the optical component 30 and the placement surface 22. The monolayer as referred to herein means a state in which only a single particle of the filler 42 is disposed in the direction normal to the placement surface 22 and in which a plurality of particles of the filler 42 is not arranged side by side in this direction. Therefore, the thickness t of the adhesive layer 40 between the optical component 30 and the placement surface 22 is less than twice the average value of particle size L of the filler 42 included in the adhesive layer 40. The substantial monolayer as referred to herein means that very small particles generated due to cracking or chipping of the filler 42 are not included in the number of layers of the filler 42.

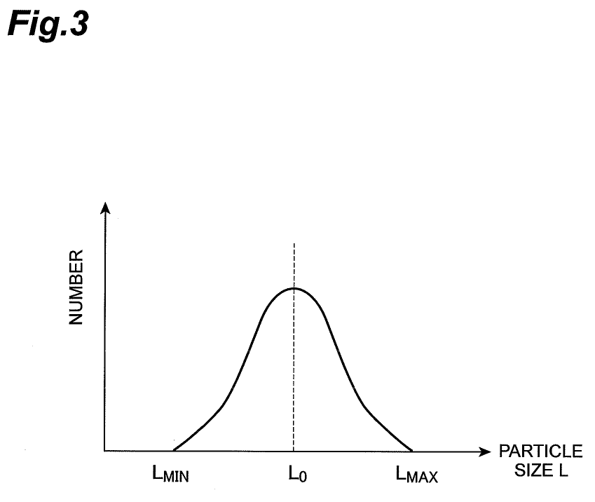

FIG. 3 is a graph illustrating an example of particle size distribution of the filler 42. As shown in FIG. 3, the particle size L of the filler 42 has a constant distribution centered, for example, on an average value L₀. The range of the particle size distribution, that is, the difference (L_{MAX}−L_{MIN}) between the maximum value L_{MAX} and minimum value L_{MIN}, is preferably a small value within 20 μm. Typically, the difference (L_{MAX}−L₀) between the maximum value L_{MAX} and the average value L₀ is equal to the difference (L_{MIN}−L₀) between the minimum value L_{MIN} and the average value L₀, and it is preferred that each be within 10 μm.

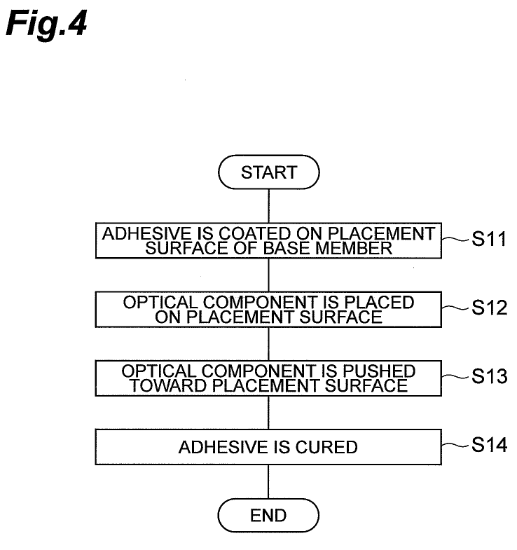

The adhesive layer 40 including such substantially monolayer filler 42 can be formed, for example, in the following manner. FIG. 4 is a flowchart illustrating an example of a method for manufacturing the mounting structure 10A for an optical component. First, an adhesive including the resin 41 and the filler 42 is coated on the placement surface 22 of the base member 20 (coating step S11). The optical component 30 is then placed on the placement surface 22 (placement step S12). In this case, the inclination of the optical component 30 may be adjusted, for example, while irradiating the upper surface of the optical component 30 with a laser beam and measuring the inclination of the optical component 30 on the basis of the reflected light. Further, in this case, the placement position of the optical component 30 can be accurately determined, for example, by positioning the optical component 30 while pressing the side surface of the optical component 30 against a jig defining the position of the optical component 30.

The optical component 30 is then pushed toward the placement surface 22 of the base member 20 by applying a pushing load to the upper surface of the optical component 30 (pushing step S13). As a result, the filler 42 introduced between the optical component 30 and the base member 20 forms a substantial monolayer. In the pushing step S 13, the extra amount of the adhesive may be allowed to escape to the groove 23. The adhesive is then cured to form the adhesive layer 40 (curing step S14).

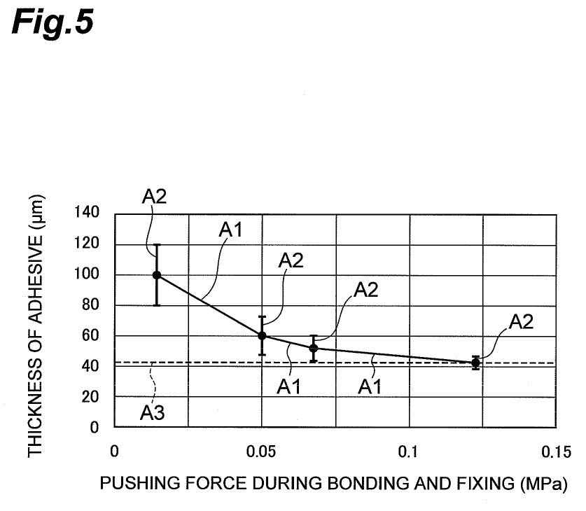

FIG. 5 is a graph illustrating an example of relationship between the pushing force acting when the optical component 30 is bonded to the base member 20 and the thickness t of the adhesive layer 40. In FIG. 5, the pushing force (units: MPa) is plotted against the abscissa, and the thickness t (units: μm) of the adhesive layer 40 is plotted against the ordinate. A broken line A1 is obtained by connecting the average values of the distribution of thickness t obtained for a plurality of adhesive layers 40. Segments A2 represent distribution ranges of thickness t of the adhesive layer 40 under each pushing force.

Referring to FIG. 5, it is clear that when the pushing force is about 0.013 MPa, the average value of the distribution of thickness t is 100 μm and the distribution range of thickness t is ±20 μm. When the pushing force is about 0.05 MPa, the average value of the distribution of thickness t is 60 μm and the distribution range of thickness t is ±12 μm. When the pushing force is about 0.07 MPa, the average value of the distribution of thickness t is 53 μm and the distribution range of thickness t is ±7.5 μm. Where the pushing force is high (0.12 MPa) by comparison with the aforementioned numerical values, the average value of the distribution of thickness t decreases to 42 μm and the distribution range of thickness t drops to ±3 μm.

Thus, it is clear that as the pushing force acting upon the optical component 30 increases, the thickness t of the adhesive layer 40 decreases and the distribution range of the thickness t is reduced. Further, where the pushing force is further increased, the thickness t gradually approaches the particle size L (shown by a broken line A3 in FIG. 5) of the filler 42. Thus, the configuration of the filler 42 approaches that of a monolayer as the pushing force acting upon the optical component 30 increases. It is preferred that the filler 42 could be reliably converted to a monolayer configuration by a pushing force equal to or higher than 0.1 MPa.

The effect obtained with the mounting structure 10A for an optical component and the manufacturing method thereof, which are described hereinabove, is explained below. As mentioned hereinabove, in the mounting structure 10A for an optical component, the filler 42 contained in the adhesive layer 40 is present substantially as a monolayer between the optical component 30 and the placement surface 22. Alternatively, the thickness of the adhesive layer 40 between the optical component 30 and the placement surface 22 is less than twice the average particle size of the filler 42. As a result, the spacing between the optical component 30 and the placement surface 22 can be maintained at a constant value defined by the particle size L of the filler 42. Therefore, with the mounting structure 10A for an optical component, the inclination of the optical component 30 can be controlled with a high accuracy.

Further, a material with a small thermal expansion coefficient, for example, such as Super-Invar, is often used as the constituent material of the base member 20 in order to inhibit changes in the distance between the optical component 30 and other optical components caused by temperature variations. Meanwhile, for example, glass with an adjusted refractive index is selected as the constituent material of the optical component 30 with consideration for light transmission or reflection characteristics. Therefore, the linear expansion coefficient of the optical component 30 can be significantly different from that of the base member 20. Even in such a case, with the mounting structure 10A for an optical component of the present embodiment, stresses generated between the optical component 30 and the base member 20 due to temperature variations can be absorbed by the resin component 41 of the adhesive layer 40, and the optical component 30 can be effectively prevented from cracking or the like.

Further, as mentioned hereinabove, it is preferred that the range of the particle size distribution of the filler 42 be within 20 (typically, within ±10 μm of the average value). By so reducing the spread in the particle size L of the filler 42, it is possible to control the inclination of the optical component 30 with an even higher accuracy.

Further, as mentioned hereinabove, the linear expansion coefficient of the optical component 30 may be ten or more times the linear expansion coefficient of the base member 20. Even when there is such a significant difference in thermal expansion coefficient between the optical component 30 and the base member 20, with the mounting structure 10A for an optical component of the present embodiment, stresses generated between the optical component 30 and the base member 20 due to temperature variations can be absorbed by the resin component 41 of the adhesive layer 40, and the optical component 30 can be effectively prevented from cracking or the like.

Referring again to FIG. 2, in the present embodiment, the excess amount of the resin 41 occurring when the adhesive layer 40 is formed overflows from the groove 23, and the outer edge 40a of the adhesive layer 40 reaches the interior of the groove 23. As a result, the contact surface area of the base member 20 and the adhesive layer 40 can be increased over that in the case where the groove 23 is not provided. Therefore, the fixing strength of the optical component 30 to the base member 20 can be further increased. In particular, in the case in which the outer edge 40a of the adhesive layer 40 reaches the interior of the groove 23 over the entire circumference of the placement surface 22, the protruding portion of the base member 20 surrounded by the groove 23 acts as an anchor, and the position of the optical component 30 can be firmly held in the direction along the placement surface 22.

### VARIATION EXAMPLE

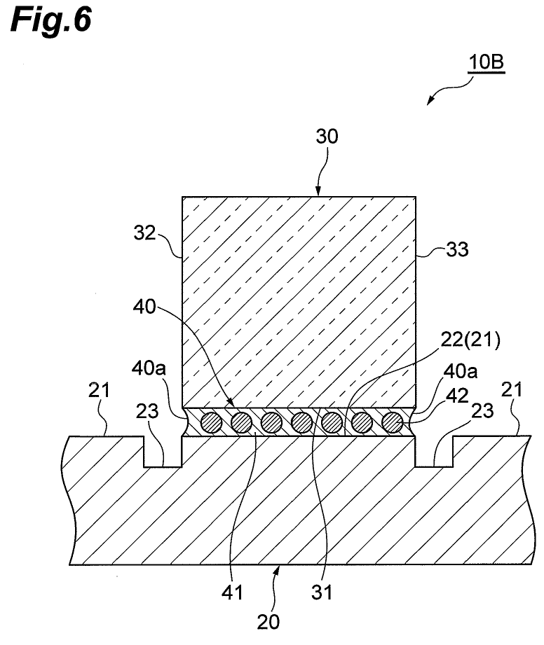

FIG. 6 is a side sectional view illustrating the configuration of a mounting structure 10B for an optical component as a variation example of the above-described embodiment. The difference between the mounting structure 10B for an optical component of the present variation example and the mounting structure 10A for an optical component of the above-described embodiment is in that whether or not the adhesive layer 40 reaches the groove 23. Thus, in the present variation example, the excess portion of the resin 41 occurring when the adhesive layer 40 is formed does not overflow from the groove 23, and the outer edge 40a of the adhesive layer 40 does not reach the interior of the groove 23. In other words, the outer edge 40a of the adhesive layer 40 is confined within the region surrounded by the groove 23.

In the case in which the outer edge 40a of the adhesive layer 40 is thus confined within the region surrounded by the groove 23, the presence range of the adhesive layer 40 is limited to the interior of the region surrounded by the groove 23. Therefore, even when the linear expansion coefficients of the optical component 30 and the base member 20 differ significantly from each other, the stretching degree of the resin 41 in the in-plane direction along the placement surface 22 can be limited to a certain value. Therefore, the resin 41 with stretching ability lower than that in the above-described embodiment can be used.

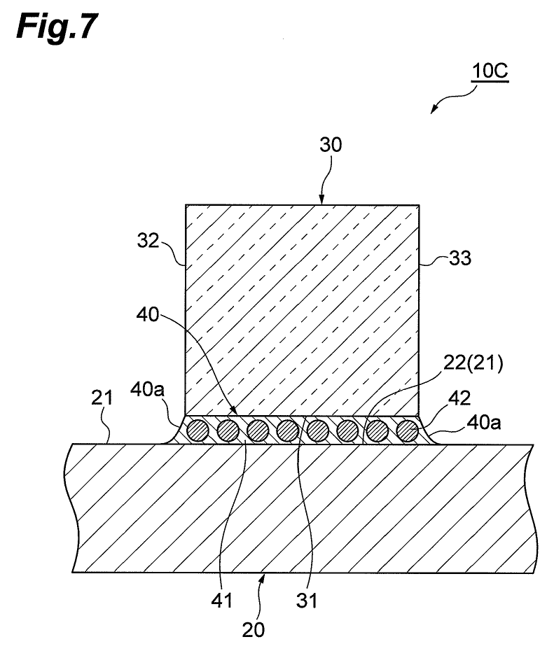

FIG. 7 is a side sectional view illustrating the configuration of a mounting structure 10C for an optical component as another variation example of the above-described embodiment. The difference between the mounting structure 10C for an optical component of the present variation example and the mounting structure 10A for an optical component of the above-described embodiment is in that whether or not the groove 23 is present. Thus, in the present variation example, the groove 23 is not formed in the base member 20, and the main surface 21 is flat. Part of the main surface 21 functions as the placement surface 22, and the optical component 30 is mounted thereon, with the adhesive layer 40 being interposed therebetween.

Even in this case in which the groove 23 is not formed in the base member 20, by ensuring that the filler 42 of the adhesive layer 40 is present substantially in the form of a monolayer, it is possible to obtain the operation effect same as that of the above-described embodiment.

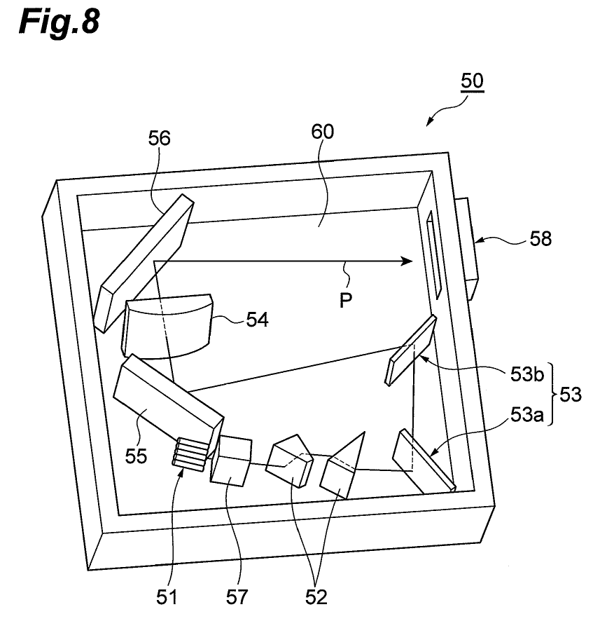

(Second Embodiment) FIG. 8 is a perspective view illustrating the configuration of a wavelength-selective device 50 as a second embodiment of the mounting structure for an optical component. The wavelength-selective device 50 is provided with a plurality of beam ports 51 for inputting and outputting a beam P, a beam expansion unit (beam expander) 52 that expands the beam P inputted from the beam ports 51, a spectral element 53 that divides the beam P expanded by the beam expansion unit 52 into optical paths that differ for each wavelength component of the beam P, a converging lens 54 that converges the beam to positions that differ for each wavelength component obtained by division in the spectral element 53, and a base member 60 supporting the aforementioned components.

Where the beam P is inputted from one beam port 51 in the wavelength-selective device 50, this beam P is expanded by the beam expansion unit 52 after passing through a collimator array 57. The beam expansion unit 52 is formed, for example, by arranging a plurality of prisms which are optically coupled to each other in a row in the optical axis direction. The beam P expanded by the beam expansion section 52 falls on the spectral element 53. The spectral element 53 is constituted, for example, by a pair of optically transmissive diffraction gratings 53a, 53b, and the beam P sequentially passes through the optically transmissive diffraction gratings 53a, 53b. In this case, since the angle of emission of the beam augmented by the diffraction action differs depending on the wavelength of the beam P, the beam P emitted from the optically transmissive diffraction grating 53b is outputted to the optical path corresponding to the wavelength thereof.

The beam P thus divided by the spectral element 53 is reflected by a return mirror 55 and then falls on the converging lens 54. The beam P is reflected by a return mirror 56 while being converged by the converging lens 54 and reaches a MEMS mirror array 58. The MEMS mirror array 58 has a structure in which a plurality of reflecting surfaces are arranged side by side in a row, and the angles of the reflective surfaces are slightly different from each other. The converged beam P is reflected at the reflective surface corresponding to the wavelength of the beam P, from among the plurality of reflective surfaces of the MEMS mirror array 58. The beam P then propagates through the same path in reverse and reaches the beam ports 51. In this case, the optical path of the beam P is made different for each wavelength thereof by the MEMS mirror array 58, and therefore the beam P reaches the beam port 51 corresponding to the wavelength of the beam P, from among the plurality of beam ports 51. The beam P is thus selectively outputted from the beam port 51 corresponding to the wavelength thereof.

In such a wavelength-selective device 50, at least one optical component from among the beam expansion unit 52, spectral element 53 and converging lens 54 is mounted on the base member 60 by the mounting structure 10A (or 10B or 10C) for an optical component according to the first embodiment. Thus, the optical component is placed on the placement surface provided in the base member 60, and an adhesive layer (corresponds to the adhesive layer 40 shown in FIG. 1) is interposed between the optical component and the placement surface of the base member 60. The adhesive layer includes a filler. The filler is present substantially as a monolayer between the optical component and the placement surface.

With the wavelength-selective device 50, the monolayer filler included in the adhesive layer can maintain a constant spacing between the base member 60 and the optical component such as the beam expansion unit 52, spectral element 53 or converging lens 54. Therefore, the inclination of the optical component such as the beam expansion unit 52, spectral element 53 or converging lens 54 can be controlled with a high accuracy and these optical components can be optically coupled with a high accuracy. As a result, the shift of the selected wavelengths can be effectively inhibited.

The wavelength-selective device 50 can be also considered as a single mounting structure for optical components. In this case, the mounting structure for optical components is provided with a plurality of optical components, namely, the beam expansion unit 52, spectral element 53, and converging lens 54, and the base member 60 having a plurality of placement surfaces, and is further provided with a plurality of adhesive layers interposed between the plurality of optical components and the plurality of placement surfaces. Further, each of the plurality of optical components is optically coupled to another optical component included in the plurality of optical components. In such a mounting structure for optical components, a constant spacing is maintained between each optical component and the placement surface of the base member 60 by a monolayer filler. Therefore, the inclination of each optical component can be controlled with a high accuracy and the optical components can be optically coupled with a high accuracy.

The preferred embodiments of the mounting structure for an optical component, the wavelength-selective device, and the method for manufacturing the mounting structure for an optical component in accordance with the present invention are described above, but the present invention is not limited to the above-described embodiments and can be variously changed without departing from the scope thereof.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A mounting structure for an optical component, comprising:
an optical component having at least one of a reflective surface which reflects light, and a transmissive surface which transmits light;
a base member having a placement surface configured to place the optical component thereon; and
an adhesive layer interposed between the optical component and the placement surface of the base member to fixedly bond the optical component and the placement surface together, wherein
the adhesive layer includes a filler, and
the filler is present substantially as a monolayer between the optical component and the placement surface.

2. The mounting structure for an optical component according to claim 1, wherein a range of a particle size distribution of the filler is within 20 μm.

3. The mounting structure for an optical component according to claim 1, wherein a linear expansion coefficient of the optical component is ten or more times a linear expansion coefficient of the base member.

4. The mounting structure for an optical component according to claim 1, wherein
the optical component is made of glass, and
the base member is made of Invar or Super-Invar.

5. The mounting structure for an optical component according to claim 1, wherein the base member further includes a groove formed to surround the placement surface.

6. The mounting structure for an optical component according to claim 5, wherein an outer edge of the adhesive layer is confined within a region surrounded by the groove.

7. The mounting structure for an optical component according to claim 5, wherein an outer edge of the adhesive layer reaches an interior of the groove.

8. The mounting structure for an optical component according to claim 1, comprising:
a plurality of the optical components;
the base member having a plurality of the placement surfaces; and
a plurality of the adhesive layers interposed between the plurality of optical components and the plurality of placement surfaces, wherein
each of the plurality of optical components is optically coupled to another optical component included in the plurality of optical components.

9. A mounting structure for an optical component, comprising:
an optical component having at least one of a reflective surface which reflects light, and a transmissive surface which transmits light;
a base member having a placement surface configured to place the optical component thereon; and
an adhesive layer interposed between the optical component and the placement surface of the base member to fixedly bond the optical component and the placement surface together, wherein
the adhesive layer includes a filler, and
a thickness of the adhesive layer between the optical component and the placement surface is less than twice an average particle size of the filler.

10. The mounting structure for an optical component according to claim 9, wherein a range of a particle size distribution of the filler is within 20 μm.

11. The mounting structure for an optical component according to claim 9, wherein a linear expansion coefficient of the optical component is ten or more times a linear expansion coefficient of the base member.

12. The mounting structure for an optical component according to claim 9, wherein
the optical component is made of glass, and
the base member is made of Invar or Super-Invar.

13. The mounting structure for an optical component according to claim 9, wherein the base member further includes a groove formed to surround the placement surface.

14. The mounting structure for an optical component according to claim 13, wherein an outer edge of the adhesive layer is confined within a region surrounded by the groove.

15. The mounting structure for an optical component according to claim 13, wherein an outer edge of the adhesive layer reaches an interior of the groove.

16. The mounting structure for an optical component according to claim 9, comprising:
a plurality of the optical components;
the base member having a plurality of the placement surfaces; and
a plurality of the adhesive layers interposed between the plurality of optical components and the plurality of placement surfaces, wherein
each of the plurality of optical components is optically coupled to another optical component included in the plurality of optical components.

17. A wavelength-selective device comprising:
a beam port that inputs a beam;
a beam expansion unit that expands the beam inputted from the beam port;
a spectral element that divides the beam expanded by the beam expansion unit into different optical paths for each wavelength component of the beam; and
a converging lens that converges the beam at different positions for each wavelength component divided by the spectral element, wherein
at least one optical component from among the beam expansion unit, the spectral element, and the converging lens is mounted on the base member by the mounting structure for an optical component according to claim 1.

18. The wavelength-selective device according to claim 17, wherein the beam expansion unit is constituted by a plurality of prisms that are optically coupled to each other.

19. A method for manufacturing a mounting structure for an optical component, comprising the steps of:
coating an adhesive including a filler on a placement surface of a base member, the placement surface being a surface configured to place an optical component having at least one of a reflective surface which reflects light, and a transmissive surface which transmits light;
placing the optical component on the placement surface;
causing the filler to be present substantially as a monolayer between the optical component and the placement surface by pushing the optical component toward the placement surface; and
curing the adhesive to form an adhesive layer.

20. The method for manufacturing a mounting structure for an optical component according to claim 19, wherein
the base member further has a groove formed so as to surround the placement surface, and
an extra amount of the adhesive is allowed to escape to the groove in the causing.
